(19) United States
(12) Patent Application Publication
(10) Pub. No.: US 2026/0046648 A1
(43) Pub. Date: Feb. 12, 2026

(54) USER EQUIPMENT AND BASE STATION RELATED TO CROSSLINK INTERFERENCE MEASUREMENT

(71) Applicant: Electronics and Telecommunications Research Institute, Daejeon (KR)

(72) Inventors: Junhyeong Kim, Daejeon (KR); IL GYU KIM, Daejeon (KR); Hee Sang Chung, Daejeon (KR); Sung Woo Choi, Daejeon (KR)

(21) Appl. No.: 19/295,458

(22) Filed: Aug. 8, 2025

(30) Foreign Application Priority Data
Aug. 8, 2024 (KR) 10-2024-0106020
Oct. 4, 2024 (KR) 10-2024-0135118
Nov. 8, 2024 (KR) 10-2024-0158238
Jul. 24, 2025 (KR) 10-2025-0100804

(51) Int. Cl. H04W 24/08; H04W 72/0446; H04W 72/21

(52) U.S. Cl. CPC H04W 24/08; H04W 72/0446; H04W 72/21

(57) ABSTRACT

User equipment according to an embodiment disclosed in the present disclosure includes a communication module configured to transmit signals to and receive signals from a serving base station; and a processor, wherein the processor is configured to receive first information related to semi-static configuration or dynamic configuration of uplink muting resources from the serving base station through first signaling via the communication module, the uplink muting resources being related to crosslink interference (CLI) measurement for reception of a physical uplink shared channel (PUSCH) of the serving base station, receive second information indicating whether to apply muting to the muting resources dynamically from the serving base station through second signaling via the communication module, and transmit the PUSCH to the serving base station through remaining resources other than muting resources in a slot determined based on the first and second information.

### CROSS-REFERENCE TO RELATED APPLICATION

This application claims priority under 35 U.S.C § 119 to Korean Patent Applications No. 10-2024-0106020, filed on Aug. 8, 2024, Korean Patent Application No. 10-2024-0135118 filed in the Korean Intellectual Property Office on Oct. 4, 2024, Korean Patent Application No. 10-2024-0158238 filed in the Korean Intellectual Property Office on Nov. 8, 2024, and Korean Patent Application No. 10-2025-0100804 filed in the Korean Intellectual Property Office on Jul. 24, 2025, the disclosure of which is incorporated herein by reference in its entirety.

### BACKGROUND

### 1. Field of the Invention

Various embodiments disclosed in the present disclosure relate to wireless communication technology.

### 2. Discussion of Related Art

The 5G New Radio (NR) standard is designed to support duplexing flexibility in a paired spectrum (frequency division duplex; hereinafter referred to as FDD) and an unpaired spectrum (time division duplex; hereinafter referred to as TDD). For example, the 5G NR standard is designed to use a dynamic TDD scheme. The dynamic TDD supports dynamic and flexible time allocation of a downlink (DL) and an uplink (UL).

FIG. 1 illustrates an example of occurrence of crosslink interference (CLI) when dynamic TDD is used in a 5G mobile communication system.

In a multi-cell environment, when dynamic resource allocation is allowed for each cell, CLI (see dotted arrows in FIG. 1) may occur between DL and UL, as illustrated in FIG. 1. CLI is roughly divided into UE-to-UE CLI (110) and gNB-to-gNB CLI (120). UE-to-UE CLI refers to interference from user equipment (UE) transmitting a UL in one cell to UE receiving a DL in another cell. gNB-to-gNB CLI refers to interference from a base station's DL transmission in one cell to UL reception in another cell.

In order to mitigate the CLI, in a 5G NR Release 16 standardization phase, research was conducted on a method for UE-to-UE CLI measurement and report, information exchange procedures for network cooperation, and an influence of interference that may occur at the time of dynamical allocation of UL/DL resources between operators who use adjacent frequencies. As a result, Release 16 specifications allow L3 level interference measurement for UE-to-UE CLI measurement and reporting, and a measurement method includes using a CLI-received signal strength indicator (CLI-RSSI) and sounding reference signal-reference signal received power (SRS-RSRP).

Further, in a standardization process of Release 18-1 of the 5G NR standard, CLI processing between gNBs of the same operator has been studied in order to implement dynamic TDD in commercial NR networks. The TDD is one half-duplex scheme, in which a base station performs transmission and reception in different time slots in the same frequency band. Therefore, the TDD divides resources in a time domain widely used in commercial 5G NR into a DL and a UL.

Incidentally, when limited time resources are allocated to the UL due to the application of TDD, problems such as reduced UL coverage, increased communication delay, and reduced UL capacity occur.

To mitigate this, subband non-overlapping full duplex (hereinafter referred to as SBFD) has been proposed as a main function of 5G-Advanced to support full-duplex communication in which both UL and DL exist in an existing TDD band, but specific implementation is still insufficient.

### SUMMARY OF THE INVENTION

The present invention has been made to solve the above-described problem, and is directed to a new method and device for CLI processing.

Specifically, the present invention is directed to a method of deactivating radio resources to improve measurement accuracy of interference link information required for application of an interference mitigation technique in a wireless communication network.

According to an aspect of the present disclosure, there is provided user equipment including a communication module configured to transmit signals to and receive signals from a serving base station; and a processor, wherein the processor is configured to receive first information related to semi-static configuration or dynamic configuration of uplink muting resources from the serving base station through first signaling via the communication module, the uplink muting resources being related to crosslink interference (CLI) measurement for reception of a physical uplink shared channel (PUSCH) of the serving base station, receive second information indicating whether to apply muting to the muting resources dynamically from the serving base station through second signaling via the communication module, and transmit the PUSCH to the serving base station through remaining resources other than muting resources in a slot determined based on the first and second information.

The first information may include a time-domain position and a frequency-domain muting pattern of at least one muting symbol in the slot.

The frequency-domain muting pattern may include a comb offset which is one of {0, 1}.

The processor may be configured to determine the muting resources based on the first and second information across a physical resource block (PRB) band of PUSCH resources on which the PUSCH is transmitted.

The processor may be configured to acquire a transmission PRB of the PUSCH and the second information through downlink control information (DCI) scheduling the PUSCH.

The processor may be configured to determine the muting resources based on an explicit frequency allocation position when the second information includes the explicit frequency allocation position of the muting resources.

The first signaling may include at least one of signaling including radio resource control (RRC) signaling of a Uu link or SL, master information block (MIB), system information block (SIB), DCI/UCI/SCI (DL/UL/SL control information), and a medium access control element (MAC CE).

The second signaling may include at least one of the signaling including DCI and MAC CE.

The processor may be configured not to apply muting to at least one symbol corresponding to the muting resources determined based on the first and second information when the at least one symbol overlaps a symbol including a demodulation RS (DM-RS).

At least one symbol corresponding to the muting resources determined based on the first and second information is either a symbol on which transform-precoding is deactivated or a symbol on which transform-precoding is activated, and the processor is configured not to apply muting to the at least one symbol when the at least one symbol is a symbol on which transform-precoding is activated and overlaps a symbol including a phase tracking RS (PT-RS).

The symbol on which transform-precoding is deactivated may be a CP-OFDM symbol, and the symbol on which transform-precoding is activated may be a DFT-S-OFDM symbol.

The processor may be configured to allocate the muting resources to a symbol in at least one of a CP-OFDM scheme in which transform-precoding is deactivated and a DFT-S-OFDM scheme in which the transform-precoding is activated.

The processor may be configured not to apply muting to the overlapping muting symbol when the muting symbol according to the muting resources overlaps a symbol including the DM-RS.

The processor may be configured not to apply muting to the overlapping muting symbol when the muting symbol according to the muting resources in the DFT-S-OFDM scheme overlaps a symbol including the PT-RS.

Further, according to an aspect of the present disclosure, there is provided a base station device including a communication module configured to transmit and receive signals with user equipment in a serving cell; and a processor, wherein the processor is configured to, in an operation of measuring crosslink interference affecting reception of a physical uplink shared channel (PUSCH) of the user equipment, transmit first information related to semi-static or dynamic configuration of uplink muting resources to the user equipment through first signaling, transmit second information for dynamically indicating whether to apply muting to the uplink muting resources to the user equipment through second signaling, and receive the PUSCH from the user equipment through remaining resources other than muting resources determined based on the first and second information.

The first information may include a time-domain position, and a frequency-domain muting pattern of at least one muting symbol in a slot of the muting resources.

The frequency-domain muting pattern may include a comb offset that is one of {0, 1}.

The processor may be configured to measure crosslink interference (CLI) received in the muting resources allocated across a physical resource block (PRB) band of a PUSCH in a slot.

The processor may be configured to transmit PRB allocation information of the PUSCH to the user equipment through downlink control information (DCI) indicating PUSCH scheduling information.

The processor may be configured to transmit the second information including the explicit frequency allocation position of the muting resources when it is desired to designate a frequency allocation position of the muting resources differently from a PUSCH frequency allocation position.

The first signaling may include at least one of signaling including radio resource control (RRC) signaling of a Uu link or SL, master information block (MIB), system information block (SIB), DCI/UCI/SCI (DL/UL/SL control information), and a medium access control element (MAC CE).

The second signaling may include at least one of the signaling including DCI and MAC CE.

The processor may be configured to transmit the first information and the second information for applying muting to at least one of a symbol on which transform-precoding is deactivated and a symbol on which transform-precoding is activated.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 illustrates occurrence of CLI when dynamic TDD is used in a 5G mobile communication system;

FIG. 2 is a configuration diagram of a base station device according to an embodiment;

FIG. 3 is a diagram illustrating a method for deactivating UL resources in SBFD of a 5G mobile communication system;

FIG. 4 illustrates a plurality of CLI-RS allocations for measurement of CLI between base stations according to an embodiment;

FIG. 5 is a diagram illustrating resource muting when CLI-RS is configured as a double-symbol according to an embodiment;

FIGS. 6A to 6D illustrate examples of application of muting patterns according to an embodiment;

FIG. 7 is an illustrative diagram of continuous symbol muting according to an embodiment;

FIG. 8 is a flowchart of a CLI measurement method according to an embodiment;

FIG. 9 is a configuration diagram of user equipment according to the embodiment; and

FIG. 10 is a flowchart of a muting resource allocation method according to an embodiment.

In connection with the description of the drawings, the same or similar components may be denoted by the same or similar reference numerals.

### DETAILED DESCRIPTION OF EXEMPLARY EMBODIMENTS

Subband non-overlapping full duplex (hereinafter referred to as SBFD) is a function of 5G-Advanced that supports full duplex communication in which both UL and DL exist in a TDD band. For example, an influence on existing standards, performance evaluation results, implementation feasibility, RF requirements, and the like are being studied for application of the SBFD scheme. For example, the influence on the existing standards and the performance evaluation resulting from enhancements to dynamic/flexible TDD technology are being studied.

Further, an SBFD operation on the gNB side in a TDD carrier, a scheme for processing gNB-to-gNB CLI and a scheme for processing UE-to-UE CLI for the SBFD operation, and RF requirements for the SBFD operation in gNB are being studied.

SBFD standardization and application are based on the following goals and assumptions. The following operations can be performed by hardware or software modules installed in at least one of a base station device and user equipment, for example.

### Goals and Assumptions of SBFD Standardization

1. Specify semi-static indication of time location of SBFD subbands to UEs in RRC_CONNECTED mode
2. Specify semi-static indication of frequency domain location of SBFD subbands to UEs in RRC_CONNECTED mode
3. Specify SBFD operation to support random access in SBFD symbols by UEs in RRC CONNECTED mode
4. Study and specify, if justified, SBFD operation to UE in RRC_IDLE/INACTIVE mode for random access
5. Specify UE transmission, reception and measurement behavior and procedures in SBFD symbols and/or non-SBFD symbols for SBFD aware UE
6. Basic assumption based on TR 38.858
   SBFD at the gNB side
   Half duplex operation at the UE side
   FR1 and FR2-1
   SBFD operation Option 4, i.e., both time and frequency locations of subbands for SBFD operation are known to SBFD aware UEs
   Coexistence between non-SBFD aware UEs (including legacy UEs) and SBFD aware UEs in the cell operating SBFD at gNB side
   SBFD scheme within a single configured DL and UL BWP pair with aligned center frequencies
   One UL subband for SBFD operation in an SBFD symbol (excluding legacy UL symbol/slot) within a TDD carrier
   Mechanisms for SBFD operation shall also consider the adjacent channel coexistence between two operators
7. Specify enhancements for CLI handling
   Information exchange among gNBs, including
      Semi-static cell-specific SBFD time and frequency location configuration
      Measurement resource configuration, i.e., SSB and/or periodic NZP CSI-RS
      Strongest DL beam information
      CLI-mitigation request

### UL Resource Muting for PUSCH, Including

Indication/determination of UL resource muting for PUSCH based on semi-static configuration, assuming comb-2 for both DFT-S-OFDM and CP-OFDM in each allocated PRB and up to 2 symbols in time domain
PUSCH resource mapping, i.e., rate-matching around the muted REs
UCI resource determination in symbols with muted REs
L1 based UE-to-UE CLI measurement and reporting based on existing CSI framework, including-Periodic, semi-persistent, or aperiodic measurement resource (set), i.e., SRS-RSRP resource or CLI-RSSI resource, and configuration/determination of ‘typeD’ QCL assumptions for the CLI
measurement resource
At least aperiodic reporting
New report quantities, e.g., L1-SRS-RSRP, L1-CLI-RSSI and/or measurement resource indices
UCI bits generation
Priority rules for multiple CSI reporting
CLI measurement accuracy requirement
Note: Without dedicated optimization for dynamic/flexible TDD.

### Notes Regarding UL Resource Muting:

No new DCI field/MAC CE is introduced for indication/determination of UL resource muting
No impact on data and control multiplexing as defined in section 6.2.7, TS 38.212
UL resource muting does not apply for Msg A PUSCH and Msg 3 PUSCH
UL resource muting applies only for UEs in RRC_CONNECTED mode
UE assumes that the UL resource muting pattern does not overlap UL DMRS or PT-RS in the same symbol
Power boosting is assumed for REs in the symbol with UL resource muting. PUSCH transmit power does not change across symbols
No changes on TBS determination for PUSCH
Check impact on transmit signal quality/MPR requirement, if any, with RAN4
This feature is subject to UE capability

FIG. 2 is a configuration diagram of a base station device according to an embodiment.

Referring to FIG. 2, a base station device 200 may include at least one of a processor 210, a communication module 220, a memory 230, an input interface device 250, an output interface device 260, and a storage device 240. For example, the processor 210 and the communication module 220 may be configured as a single undivided entity. At least some operations of the processor 210 and the communication module 220 performed in the present disclosure may be performed via one or more components that constitute the base station device 200. In an embodiment, the base station device 200 may be a base station. Further, a case in which the base station device 200 operates as a serving base station will be described as an example with reference to FIG. 2.

The processor 210 may control at least one other component (for example, a hardware or software component) of the base station device 200 and perform various data processing or calculations related to communication according to the present invention.

The processor 210 may be a central processing unit (CPU) or may be a semiconductor device that executes instructions stored in the memory 230 or the storage device 240. The processor 210 may include hardware/software blocks that process functions of a modem and an upper protocol. The processor 210 may include, for example, at least one of a CPU, a graphics processing unit (GPU), a microprocessor, an application processor, an application specific integrated circuit (ASIC), and a field programmable gate array (FPGA), and may include a plurality of cores.

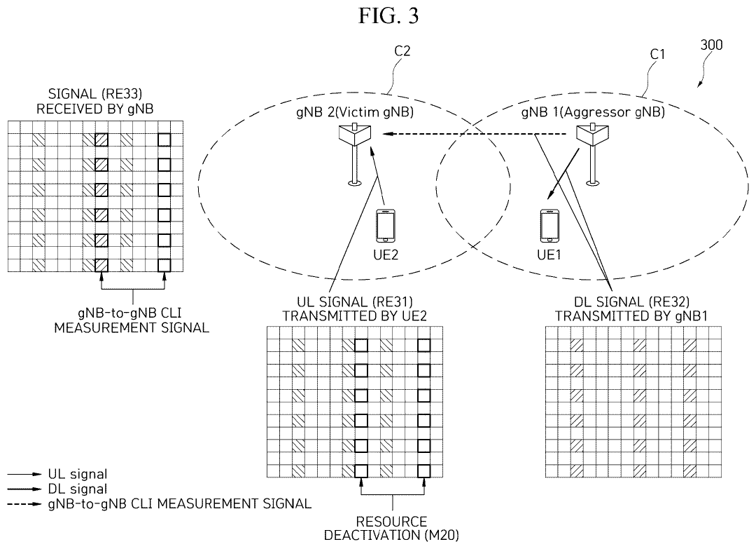

The communication module 220 may support establishment of a communication channel or a wireless communication channel between the base station device 200 and another device (for example, user equipment (such as UE2 in FIG. 3) or another base station), and communication through the established communication channel. The communication channel may include, for example, at least one communication channel among LAN, FTTH, xDSL, Wibro, Wireless LAN, Wi-Fi, Bluetooth, Zigbee, Wi-Fi Direct (WFD), Ultrawideband (UWB), Infrared Data Association (IrDA), Bluetooth Low Energy (BLE), near field communication (NFC), 3G, 4G, 5G, and 6G. The communication module 220 may include components for signal transmission and reception, such as components related to signal transmission (for example, a carrier wave generation unit) including an antenna.

The memory 230 and the storage device 240 may include various types of volatile or nonvolatile storage media. For example, the memory 230 may include a read only memory (ROM) and a random access memory (RAM). In the embodiment of the present disclosure, the memory 230 may be located inside or outside the processor 210, and the memory 230 may be connected to the processor 210 through various known means.

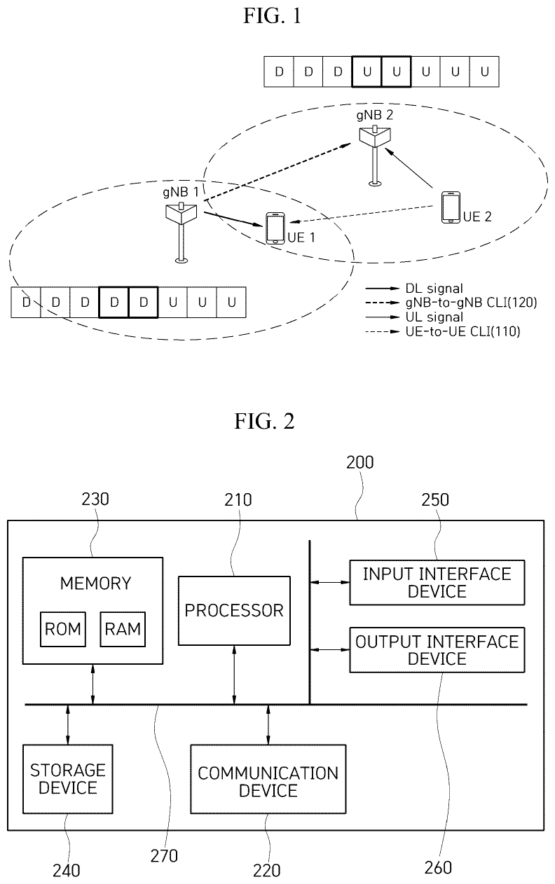

According to an embodiment, the processor 210 may allocate uplink muting resources related to the physical uplink shared channel (PUSCH) to the user equipment (for example, UE2 of FIG. 1) in order to measure crosslink interference affecting the PUSCH reception of the user equipment. The muting resources may be, for example, uplink resources of the user equipment in a serving cell that overlap downlink resources of a neighboring base station.

For example, the processor 210 may transmit the first information related to semi-static or dynamic configuration of the uplink muting resources to the user equipment through the first signaling. The first information may include a time-domain position and a frequency-domain muting pattern of at least one muting symbol in the slot for the muting resources. The frequency-domain muting pattern may include, for example, a comb offset, which is one of {0, 1} corresponding to a set format. The first signaling may include at least one signaling among radio resource control (RRC) signaling of a Uu link or SL, master information block (MIB), system information block (SIB), DCI/UCI/SCI (DL/UL/SL control information), and a medium access control element (MAC CE).

Further, the processor 210 may transmit second information for dynamically indicating whether to apply muting to the muting resources according to the first information to the user equipment through the second signaling. For example, the processor 210 may transmit the PRB allocation information of the PUSCH to the user equipment through downlink control information (DCI) indicating the PUSCH scheduling information. In another example, when it is desired to designate the frequency allocation position of the muting resources differently from the PUSCH frequency allocation position, the processor 210 may transmit the second information including the explicit frequency allocation position of the muting resources. In this case, the user equipment may allocate the muting resources based on an explicit allocation position. The second signaling may include signaling including at least one of the DCI or medium access control element (MAC CE).

In this case, the user equipment may receive the first and second information, allocate remaining resources other than the muting resources in the slot to the PUSCH based on the first and second information, and transmit a PUSCH signal using the remaining resources. For example, the user equipment may allocate the muting resources based on the first and second information, and allocate the remaining resources other than the muting resources to the PUSCH.

The processor 210 may receive, from the user equipment, the PUSCH signal transmitted using the remaining resources other than the muting resources in the slot based on the first and second information.

In an embodiment, the processor 210 may transmit the first information and the second information that can be applied to at least one of a CP-OFDM scheme in which transform-precoding is deactivated and a DFT-S-OFDM scheme in which the transform-precoding is activated.

According to an embodiment, the processor 210 may measure crosslink interference (CLI) received in the muting resources allocated across the PRB band of the PUSCH in the slot.

In the present disclosure, a scenario of deactivating/muting some radio resources of the UL when the user equipment transmits the PUSCH in order to measure the CLI between base stations (such as the base station device 200) (gNB-to-gNB CLI) will be described. However, the present invention is not limited thereto. For example, the same may be applied to a case in which some radio resources of the DL are deactivated/muted when the base station transmits a PDSCH for measurement of CLI between user equipment (UE-to-UE CLI).

In the present specification, the base station or the user equipment may be any communication node, including a gNodeB (gNB), an eNodeB (eNB), a transmission reception point (TRP), a fixed/mobile repeater, a Wi-Fi access point (AP), UE, or the like, or an antenna of the communication node.

A mobile communication scenario between a base station and user equipment presented in the embodiment of the present invention may also be applied to various communication schemes, such as a communication scenario between a Wi-Fi AP and Wi-Fi user equipment, device-to-device (D2D) communication, which is a communication scheme between user equipment, or side link (SL) communication. Therefore, although the present specification will be described by mainly using general cellular communication terms such as DL and UL, the present invention is not limited thereto. For example, the method according to an embodiment of the present invention may be applied identically or similarly to various wireless communication systems, including Wi-Fi.

Further, the base station and the user equipment may include communication nodes installed on aircraft, ships, satellites, high altitude platform stations (HAPSs), unmanned aerial vehicles/drones, and the like. Further, the following description is based on SBFD, but the description may also be applied to an in-band full duplex scheme. Further, for convenience of description, a scenario in which the base station deactivates/mutes some radio resources when the user equipment transmits a PUSCH to measure CLI between base stations (gNB-to-gNB CLI) in SBFD communication will be mainly described, but the same may be applied to a case in which the user equipment deactivates/mutes some radio resources when the base station transmits a PDSCH to measure CLI between user equipment (UE-to-UE CLI).

FIG. 3 is a diagram illustrating a method for deactivating UL resources in SBFD of a 5G mobile communication system. In SBFD, some subbands in the same frequency band are used for transmission and other subbands are used for reception. SBFD is based on a TDD structure, and separates UL and DL on a per-frequency basis. SBFD separates subbands in a frequency domain to allow UL and DL to be used simultaneously without switching delay.

Referring to FIG. 3, a mobile communication system 300 may include a plurality of base stations (gNB1 and gNB2) (such as the base station device 200 of FIG. 2), and user equipment UE1 and UE2 that performs mobile communication via the base stations gNB1 or gNB2.

A signal for processing CLI between base stations is required not to collide with an uplink signal transmitted by the user equipment, so that the signal can be accurately measured and analyzed. In an embodiment, a first base station gNB1 may be a base station that transmits a CLI-RS, and a second base station gNB2 may be a base station that performs measurement on the CLI-RS transmitted by the first base station gNB1. Both the first base station gNB1 and the second base station gNB2 may be an aggressor gNB (Agg-gNB) that generates a CLI signal and a victim gNB (Vic-gNB) that is affected by the CLI. Here, Agg-gNB is a gNB that is currently affecting or is likely to affect gNB-to-gNB CLI, and Vic-gNB is a gNB that is affected or is likely to be affected by gNB-to-gNB CLI.

The first base station gNB1 (for example, the base station device 200 of FIG. 2) may periodically, aperiodically, or semi-persistently transmit a reference signal for measurement of CLI between base stations (gNB-to-gNB) (hereinafter referred to as “CLI-RS”) to the second base station gNB2.

Thereafter, the second base station gNB2 or the user equipment (for example, UE2) may receive the CLI-RS and measure a channel, quality/strength, and interference covariance matrix of the CLI based on the CLI-RS. The user equipment or the base station (for example, gNB2) may calculate the quality/strength of the CLI through RSRP and RSSI information. In this case, RSSI measurement for the CLI does not require precise timing synchronization with a CLI-RS transmission stage, but the RSRP measurement for the CLI requires precise timing synchronization with the CLI-RS transmission stage and a certain level of demodulation processing. The channel measurement of the CLI may be similar.

Incidentally, when a transmission stage and a reception stage are physically far apart from each other, the CLI-RS signal from the transmission stage may be transmitted outside a reception timing boundary of the reception stage. In this case, a timing alignment issue may occur in which the reception stage cannot measure the RSRP or channel for the CLI. The timing alignment issue may occur more frequently in a scenario in which an FR2 band (high frequency band) of 5G NR is used. For example, when the FR2 band is used, a subcarrier spacing (hereinafter referred to as SCS) needs to be set to at least 60 kHz, which makes a length of a cyclic prefix (CP) of an orthogonal frequency division multiplexing (OFDM) symbol very short. When the SCS is 60 kHz, the CP length may be as short as 1.17 μs. Therefore, when a distance between the transmission stage and the reception stage exceeds 351 m, propagation delay deviates from the CP, making it difficult to achieve accurate RSRP and channel estimation. The timing alignment issue may also occur when a CLI channel or covariance matrix is calculated through UL resource muting. Such a timing alignment issue may cause various problems, such as beamforming/management failure, link disconnection due to a CSI error, increased adaptive modulation/coding error, or increased inter-cell interference.

To avoid such problems, base stations (for example, gNB2 in FIG. 3) according to an embodiment may deactivate at least some resources of uplink related to transmission of the CLI-RS.

For example, the first base station gNB1 may transmit radio resource configuration information for processing the CLI with the second base station gNB2.

The second base station gNB2 may check a section of the uplink resources that overlaps a transmission slot of the CLI-RS of the second base station gNB2 among downlink resources of the first base station gNB1 sharing the second cell being managed based on the radio resource configuration information. The second base station gNB2 may instruct muting for the section of the uplink resources checked when the user equipment (for example, UE2) in the second cell C2 being managed transmits PUSCH. For example, the second base station gNB2 may perform control so that at least some radio resources (M20) of the uplink related to a CLI-RS transmission/reception slot and/or subcarrier with the first base station gNB1 are deactivated.

Referring to radio resources RE31 (resource element) of FIG. 3, the second base station gNB2 may check the 8th and 12th symbols related to the transmission of the reference signal related to CLI-RS in the uplink and downlink, based on radio resource RE31 of the uplink in the serving cell that overlaps the radio resource RE32 related to the transmission of the downlink of the first base station gNB1. The second base station gNB2 may instruct the user equipment in the serving cell to provide semi-static configuration information for the muting resources M20 of the uplink in the serving cell, such as at least one of a sub carrier (each row of the UL signal RE31) and an OFDM symbol number (each column of the UL signal CR31).

According to an embodiment, the first base station gNB1 and the second base station gNB2 may set and use signal of the following channel as CLI-RS.
Data signal of PDCCH/PDSCH (Physical DL Control/Shared Channel)
DMRS (Demodulation RS) of PDCCH/PDSCH (Physical DL Control/Shared Channel)
DMRS of PBCH (Physical Broadcast Channel)
CSI-RS (Channel State Information RS)
TRS (Tracking RS)
PSS (Primary Synchronization Signal)
SSS (Secondary Synchronization Signal)
PTRS (Phase Tracking RS

The second base station gNB2 calculates a covariance matrix of the crosslink interference between the base stations (gNB-to-gNB CLI) using the CLI-RS, and applies the calculated covariance matrix to a minimum mean square error and interference rejection combiner (MMSE-IRC) receiver, thereby suppressing the gNB-to-gNB CLI. For example, the second base station gNB2 may check an interference space structure (a direction or antenna in which the crosslink interference is strong) based on the calculated covariance matrix. And the second base station gNB2 may suppress the crosslink interference through beamforming or antenna optimization, interference direction removal, or cooperative beam management (mutual transmission beam adjustment through sharing of covariance matrix information with a neighboring base station).

The case in which the second base station gNB2 mutes resources overlapping the CLI-RS signal with the first base station gNB1 among all UL resources for the user equipment UE2 transmitting the PUSCH in the second cell C2 has been described as an example with reference to FIG. 3. However, the present invention is not limited thereto. For example, the present invention may be applied to a case in which the first base station gNB1 deactivates the resources overlapping the CLI-RS signal with the second base station gNB2 among all the UL resources of the user equipment UE1 in the first cell C1. Alternatively, the first base station or the second base station gNB2 may also deactivate/mute some radio resources when transmitting the PDSCH for measurement of CLI between the first user equipment UE and the second user equipment UE2 (UE-to-UE CLI).

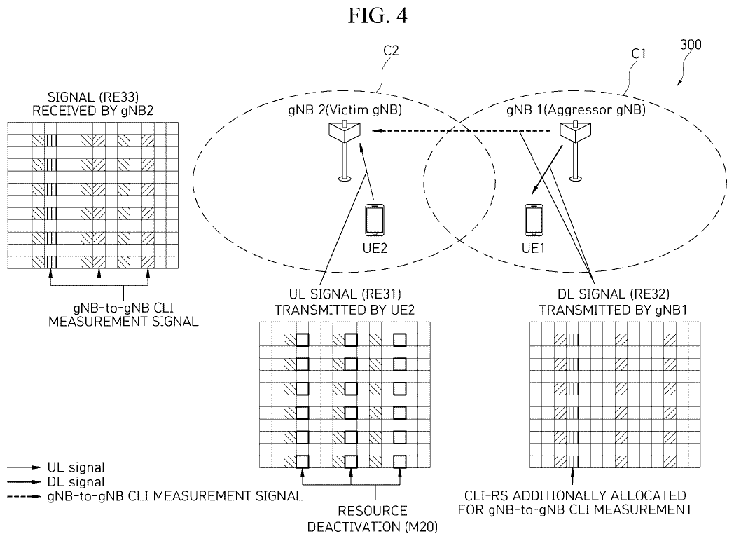

FIG. 4 illustrates a plurality of CLI-RS allocations for measurement of CLI between base stations according to an embodiment.

Referring to FIG. 4, the first base station gNB1 according to an embodiment may set 8th and 12th allocated DMRSs as CLI-RSs and allocate a CLI-RS dedicated to CLI measurement to a 4th symbol.

The second base station gNB2 may schedule the second user equipment (for example, UE2) in the second cell C2 being managed, to mute radio resources of 4th, 8th, and 12th symbols in a comb-2 form upon uplink transmission. The comb-2 form may be a scheme of arranging reference signals at intervals of two resource elements (REs). Accordingly, the second base station gNB2 may receive CLI-RS included in the 4th, 8th, and 12th symbols in the downlink signal transmitted from the first base station gNB1 without collision due to crosslink interference.

The second base station gNB2 may construct semi-static configuration information for instructing to mute uplink resources of the second user equipment (for example, UE2) and transmit the constructed semi-static configuration information to the second user equipment (for example, UE2).

In an embodiment, when the second user equipment (for example, UE2) receives the semi-static configuration information from the second base station gNB2, the second user equipment (for example, UE2) may mute some of the uplink resources based on the received semi-static configuration information.

According to an embodiment, the second base station gNB2 may transmit frequency resources, time resources, periods, and muting patterns of the muting resources to be applied to the second user equipment (for example, UE2) to the second user equipment UE2 through the semi-static configuration information (first information) via the first signaling. For example, the second base station gNB2 may configure one or more muting patterns of uplink resources in the second user equipment UE2 through the semi-static configuration information. Each configured muting pattern may include at least one of a time position configuration and a frequency position configuration. The time position configuration may include, for example, at least one of one or more symbol positions in a slot and one or more slot positions within a period in which resource muting is applied. The frequency position configuration may be, for example, one of {0, 1} as a comb offset value.

The second base station gNB2 may transmit information (second information) for dynamically indicating a resource muting pattern corresponding to the semi-static configuration information (first information) through the second signaling. For example, when a muting pattern is set for one uplink resource, the second base station gNB2 may transmit, through the second signaling, second information for dynamically indicating whether to apply muting to the muting resources according to the resource muting pattern. In another example, when the muting pattern is set for a plurality of uplink resources, the second base station gNB2 may dynamically indicate whether to apply the muting pattern to application resources (muting resources) among the plurality of uplink resources. The second signaling may be performed, for example, through DCI or MAC CE.

In an embodiment, in the case of the muting pattern, different patterns or a common pattern may be applied to the DFT-S-OFDM symbol and the CP-OFDM symbol.

In an embodiment, muting frequency resources may be set to all or some of the PUSCH resources transmitted by the second user equipment UE2. The second base station gNB2 may allocate a muting symbol corresponding to the muting resources based on the first and second information across a PRB band of the muting frequency resources.

For example, the second base station gNB2 may set a frequency position of the muting resources to the entire PRB band in which the PUSCH is transmitted. In this case, the second base station gNB2 may inform the second user equipment UE2 of the second information including the explicit frequency allocation position of the muting resources through explicit signaling (for example, a signaling method including a frequency resource start point and frequency bandwidth information or a signaling method using a bitmap). For example, when it is desired to designate the frequency allocation position of the muting resources differently from the PUSCH frequency allocation position, the second base station gNB2 may transmit the second information including the explicit frequency allocation position of the muting resources. Alternatively, when the frequency position of the muting resources is the same as the PUSCH frequency resource, the second base station gNB2 may omit the signaling. In this case, the second user equipment UE2 may allocate the muting resources based on the explicit allocation position of the muting resources included in the second information.

In an embodiment, frequency position information of the muting resources may be set as a start point of the PRB and bandwidth information of the PRB. The frequency position of the muting resources may be included as part of PUSCH frequency resources. Alternatively, the muting frequency resources may be set to be different from the PUSCH frequency resources or not to be included in the PUSCH frequency resources. In this case, a frequency section of deactivated frequency resources overlapping the PUSCH frequency resources may be selectively muted.

In an embodiment, time resource information of the muting resources may include a frame number, a slot number, and a symbol number. The symbol number may be designated, for example, with reference to symbol numbers 0 to 13 in a slot. Alternatively, the second base station gNB2 may inform the user equipment of a CLI-RS pattern and designate the time resource information of the muting resources based on the CLI-RS symbol number.

In an example of FIG. 3, the second base station gNB2 may designate {7, 11} as uplink transmission muting symbols of the second user equipment UE2 with reference to the symbol number in the slot. Alternatively, the second base station gNB2 may provide the second user equipment UE2 with a DL DMRS pattern of the second user equipment UE2 or a DL DMRS pattern of the first user equipment UE1, and notify of {1, 2} other than 0 with reference to a DMRS symbol number of the provided pattern so that a muting symbol can be designated.

The muting pattern may be set to be the same as the signal pattern of the downlink or uplink. In this case, the applicable muting pattern may include a pattern of the RS below.
DMRS (Demodulation RS) of PDCCH/PDSCH (Physical DL Control/Shared Channel)
DMRS of PBCH (Physical Broadcast Channel)
CSI-RS (Channel State Information RS)
TRS (Tracking RS)
PSS (Primary Synchronization Signal)
SSS (Secondary Synchronization Signal)
PTRS (Phase Tracking RS)
SRS (Sounding RS)
DMRS of PUCCH/PUSCH (Physical UL Control/Shared Channel)

The second base station gNB2 may inform the user equipment of the muting pattern to be applied through the first signaling.

When CLI-RS is allocated to N_{symb} symbols (N_{symb}≥1) in the slot, the second base station gNB2 may be configured to mute Nₘᵤₜₑ symbols through signaling. Here, 0≤Nₘᵤₜₑ≤N_{symb}.

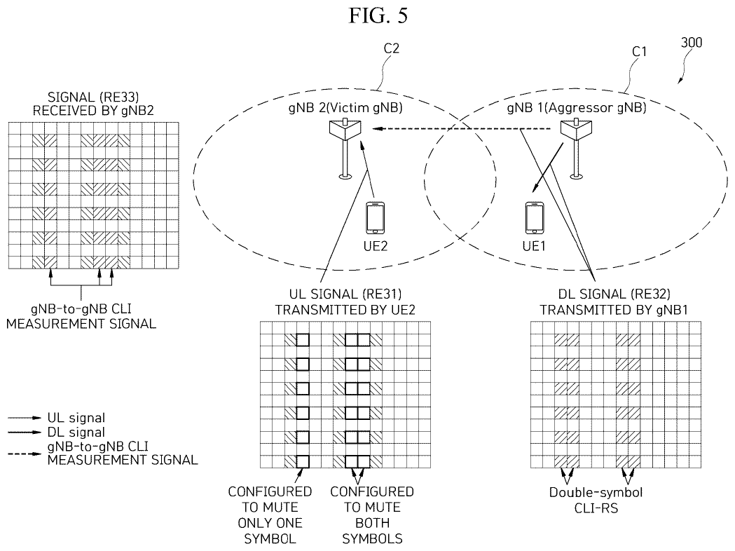

FIG. 5 is a diagram illustrating resource muting when CLI-RS is configured as a double-symbol according to an embodiment.

Referring to FIG. 5, when DMRS is a double-symbol, user equipment (for example, UE1) may mute at least one of the two symbols. For example, the user equipment (for example, UE1) may mute both the symbols or may mute only one of the symbols through base station signaling. However, when a part of CLI-RS overlaps a reference signal transmitted by the user equipment, such as DMRS, PT-RS, or SRS, only symbols that do not overlap the reference signal among the symbols overlapping the CLI-RS may be selectively muted.

According to an embodiment, when muting resources (a muting symbol) overlap an RS transmitted by the user equipment (for example, DMRS, PT-RS, or SRS), the second base station gNB2 may operate as follows.

In an embodiment, when the muting resources overlap the RS symbol of the uplink of the user equipment, the second base station gNB2 may be configured to selectively mute only non-overlapping symbols. For example, the second base station gNB2 may not apply resource muting to the overlapping symbols and preferentially allocate and transmit the RS.

In an embodiment, when the muting resources are allocated to the same symbol as the uplink RS of the user equipment and the muting resources overlap some REs of the uplink RS, the resource muting may not be applied to the symbol and preferentially allocate the RS.

However, when the second base station gNB2 cannot apply resource muting in a slot where gNB-to-gNB CLI is expected due to DL transmission of Agg-gNB according to the rule, the second base station gNB2 may apply the resource muting by applying a priority of resource muting higher than RS in at least one symbol and may omit RS transmission in the symbol.

According to an embodiment, when the second base station gNB2 operates in DFT-S-OFDM (when the transform-precoding is activated) and the PT-RS and the muting resources overlap in a specific symbol, the second base station gNB2 may issue an instruction so that the PT-RS and the muting resources cannot be simultaneously allocated in a single symbol (generate the semi-static configuration information). For example, the second base station gNB2 may be allocated to only one of the PT-RS or the resource muting to a specific symbol.

According to an embodiment, the second base station gNB2 may determine priority between PR-RS and muting resources as follows.

In an embodiment, when a PUSCH is transmitted in a slot where gNB-to-gNB CLI is expected to occur, the second base station gNB2 may generate the semi-static configuration information to apply muting resources to at least one symbol in the slot. For example, when one muting symbol overlaps the PT-RS remaining due to the lower priority than other RSs, the muting resources may be preferentially applied. In another example, when only one of the two resource muting symbols applicable in a slot overlaps the PT-RS, a non-overlapping symbol may be applied as muting resources, and therefore the non-overlapping symbol may be applied as muting resources, and the PT-RS may be preferentially allocated to the overlapping symbol.

In an embodiment, when a PUSCH is transmitted in a slot where gNB-to-gNB CLI is not expected to occur, the second base station gNB2 may indicate application of resource muting through the first signaling, or the second user equipment UE2 may determine to apply resource muting on its own based on semi-static configuration information received in advance.

In an embodiment, when the second base station gNB2 transmits a PUSCH in a slot where gNB-to-gNB CLI is not expected to occur, the second base station gNB2 may preferentially allocate a PT-RS over the resource muting.

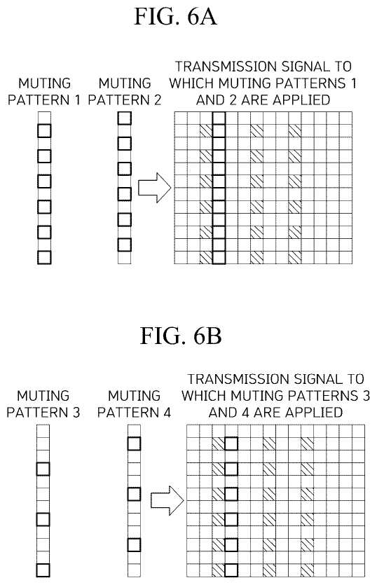

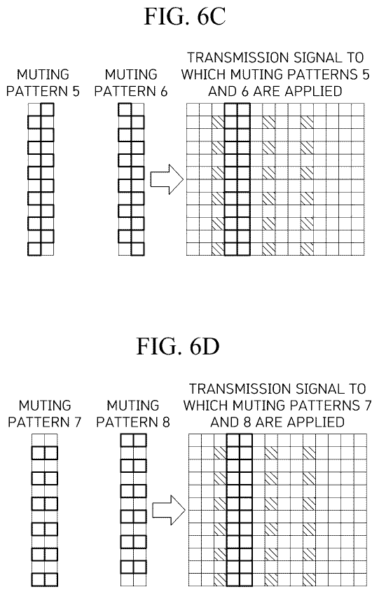

FIGS. 6A to 6D illustrate examples of application of muting patterns according to an embodiment.

Referring to FIGS. 6A to 6D, the second base station gNB2 may mute resources of the uplink and/or downlink using muting patterns including a muting symbol set. The muting symbol set may include at least one muting symbol corresponding to frequency resources or time resources of the muting symbol.

Referring to FIGS. 6A and 6B, the second base station gNB2 may apply a plurality of muting patterns to a plurality of frequency resources (a plurality of subcarriers) within time resources. In FIG. 6A, muting pattern 1 may be a comb-2 muting pattern having a comb offset value of 0, and muting pattern 2 may be a comb-2 muting pattern having a comb offset value of 1. In FIG. 6B, muting pattern 3 may be a comb-4 muting pattern having a comb offset value of 0, and muting pattern 4 may be a comb-4 muting pattern having a comb offset value of 2.

In an example of FIG. 6A, the second base station gNB2 may acquire muting patterns 1 and 2 when receiving the radio resource configuration information from the first base station gNB1 and another neighboring base station (not shown). In this case, the second base station gNB2 may transmit semi-static configuration information to which both of the acquired muting patterns 1 and 2 applied to the user equipment UE2 in the second cell. Accordingly, the second user equipment UE2 may mute time and frequency resources corresponding to muting patterns 1 and 2 among uplink resources. For example, in FIG. 6B, the second base station gNB2 may acquire muting patterns 3 and 4 when receiving the radio resource configuration information from the first base station gNB1 and another neighboring base station (not shown). In this case, the second base station gNB2 may transmit semi-static configuration information to which both of the acquired muting patterns 3 and 4 have been applied to the user equipment UE2 in the second cell. Accordingly, the second user equipment UE2 may mute time and frequency resources corresponding to muting patterns 3 and 4 among the uplink resources.

Similarly, referring to FIGS. 6C and 6D, the second base station gNB2 may apply double-symbol type muting patterns 5 and 6 to a plurality of frequency resources (a plurality of subcarriers) in a plurality of time resources. For example, the second base station gNB2 may acquire muting patterns 5 and 6 in the case of FIG. 6C (muting patterns 7 and 8 in the case of FIG. 6D) when receiving the radio resource configuration information from the first base station gNB1 and another neighboring base station (not shown). In this case, the second base station gNB2 may transmit the semi-static configuration information to which both of the acquired muting patterns 5 and 6 have been applied to the user equipment UE2 in the second cell. Accordingly, the second user equipment UE2 may be configured to mute time resources and frequency resources corresponding to muting patterns 5 and 6 in the case of FIG. 6C (muting patterns 7 and 8 in the case of FIG. 6D) among the uplink resources.

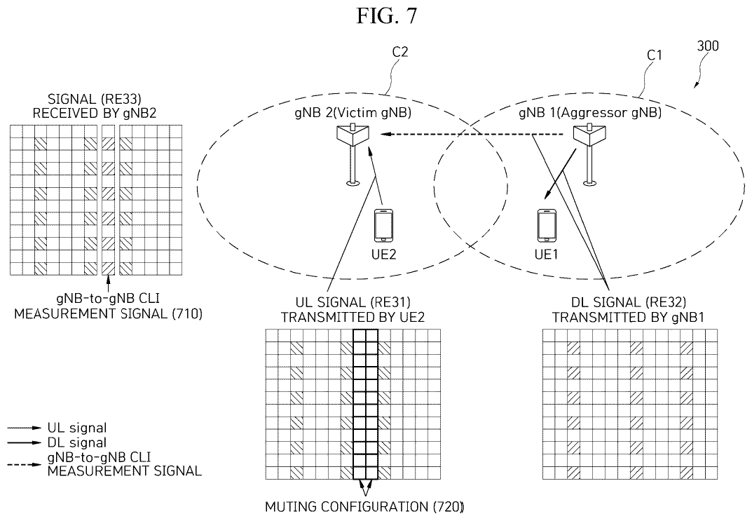

FIG. 7 is an illustrative diagram of continuous symbol muting according to an embodiment.

Referring to FIG. 7, the second base station gNB2 may receive the CLI-RS by muting one symbol 710 in the uplink of the user equipment UE2. In this case, the second base station gNB2 may check, for example, timing misalignment between the CLI-RS transmitted from the first base station gNB1 and the uplink signal of the user equipment UE1 due to a physical distance from the base station gNB1. For example, the second base station gNB2 may check the timing misalignment based on a difference between an expected position of the reference signal and an actual reception position. In another example, the second base station gNB2 may check the timing misalignment using at least one of analysis of a TA value from the user equipment UE2, UL/DL timing comparison, or time correlation analysis for IQ samples.

Accordingly, the second base station gNB2 may instruct the user equipment UE2 to mute two consecutive symbols 720 when receiving the second CLI-RS from the first base station gNB1.

Thus, with the mobile communication system 300 according to the embodiment, it is possible to deactivate resources likely to cause crosslink interference by overlapping a slot and a subcarrier in which the CLI-RS signal is transmitted in the user equipment or base station using the SBFD communication, thereby supporting more accurate measurement of the crosslink interference.

Therefore, with the mobile communication system 300 according to the embodiment, it is possible to prevent or mitigate various problems that occur due to the user equipment or base station failing to accurately estimate the CLI-RS signal, such as beamforming/management failure, link disconnection due to a CSI error, increase in adaptive modulation/coding error, or increase in inter-cell interference.

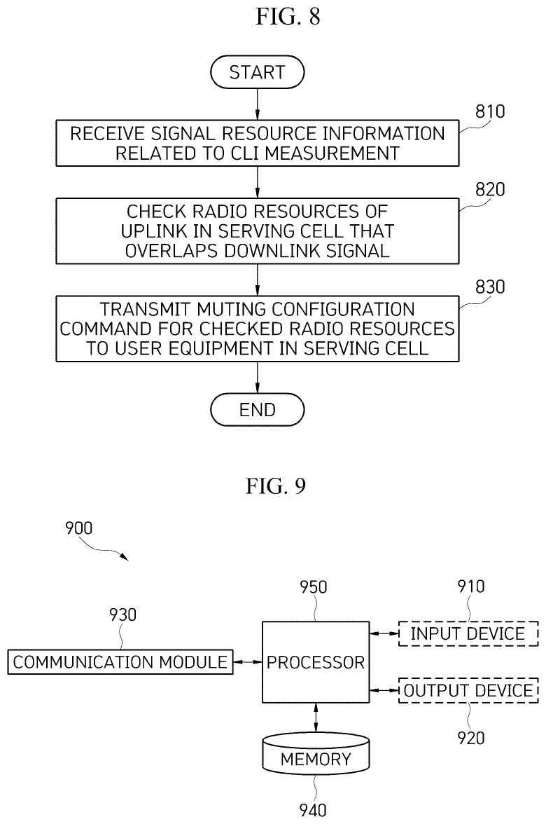

FIG. 8 illustrates a flowchart of a CLI measurement method according to an embodiment.

Referring to FIG. 8, in operation 810, the base station device 200 may receive signal resource information related to downlink CLI measurement from a neighboring base station.

In operation 820, the base station device 200 may check the radio resources of the uplink in the serving cell that overlaps the radio resources related to a downlink signal based on the received resource information.

In operation 830, the base station device 200 may transmit a muting configuration command for the checked radio resources to the user equipment in the serving cell. The muting configuration command may include first information related to the semi-static/dynamic configuration for UL muting resources that affect PUSCH reception of the user equipment and second information for indicating whether to apply muting to the muting resources.

FIG. 9 is a configuration diagram of the user equipment according to the embodiment.

Referring to FIG. 9, user equipment 900 according to an embodiment may include a communication module 930, a memory 940, and a processor 950. In an embodiment, the user equipment 900 may not include some components or may include additional components. For example, the user equipment 900 may further include an input device 910 and an output device 920. Further, some of the components of the user equipment 900 may be combined to form a single entity, which can perform functions of the components before combination in the same manner. For example, the processor 950 and the communication module 930 may be configured as a single undivided entity. At least some operations of the processor 950 and the communication module 930 performed in the present disclosure may be performed through at least one or more components that constitute the user equipment 900.

The input device 910 may receive an input from a user who uses the user equipment 900. The input device 910 may include, for example, at least one of input detection circuits including a button, a touch screen, and a microphone.

The output device 920 may output at least one of data including symbols, numbers, or characters visually or audibly under the control of the processor 950. The output device 920 may include, for example, at least one of output devices including a liquid crystal display, an OLED, a touch screen display, and a speaker.

The communication module 930 may support establishment of a communication channel or a wireless communication channel between the user equipment 900 and another device (for example, a base station device), and communication through the established communication channel. The communication channel may include, for example, at least one communication channel among LAN, FTTH, xDSL, Wibro, Wireless LAN, Wi-Fi, Bluetooth, Zigbee, Wi-Fi Direct (WFD), Ultrawideband (UWB), Infrared Data Association (IrDA), Bluetooth Low Energy (BLE), near field communication (NFC), 3G, 4G, 5G, and 6G. The communication module 930 may include components for signal transmission and reception, such as components related to signal transmission (for example, a carrier wave generation unit) including an antenna.

The memory 940 may include various volatile memories or nonvolatile memories. For example, the memory 940 may include a read only memory (ROM) and a random access memory (RAM). In an embodiment, the memory 940 may be located inside or outside the processor 950, and the memory 940 may be connected to the processor 950 via various known means. The memory 940 may store various pieces of data that are used by at least one component (for example, the processor 950) of the user equipment 900. The data may include, for example, input data or output data for software and instructions related thereto. For example, the memory 940 may store at least one instruction and data for providing a resource muting function related to the CLI measurement.

The processor 950 may control at least one other component (for example, a hardware or software component) of the user equipment 900 and may perform various data processing or operations related to communication according to the present invention. The processor 950 may include hardware/software blocks that process functions of a modem and an upper protocol. The processor 950 may include, for example, at least one of a CPU, a GPU, a microprocessor, an application processor, an ASIC, and an FPGA, and may include a plurality of cores.

According to an embodiment, the processor 950 may receive the first information related to semi-static or dynamic setting of the uplink muting resources from the serving base station through a first signaling via the communication module 930. The uplink muting resources may be, for example, empty resources REs in the form of a comb related to the CLI measurement affecting reception of the PUSCH of the serving base station. The first information may include at least a time-domain position of at least one muting symbol in the slot and a frequency-domain muting pattern. The frequency-domain muting pattern may include, for example, a comb offset, which is one of {0, 1}. The first signaling may include at least one signaling among RRC signaling of a Uu link or SL, MIB, SIB, DCI/UCI/SCI (DL/UL/SL control information), and MAC CE.

According to an embodiment, the processor 950 may receive second information for dynamically indicating whether to apply muting (muting ON/activation or muting OFF/deactivation) to the muting resources according to the first information from the serving base station through the second signaling via the communication module 930. The processor 950 may acquire, for example, transmission PRB allocation information of the PUSCH resources and the second information through the DCI indicating PUSCH scheduling information. The second signaling may include, for example, at least one of signaling including DCI and MAC CE.

According to an embodiment, the processor 950 may allocate muting resources in the slot based on the first and second information and allocate the remaining resources other than the muting resources to the PUSCH. For example, the processor 950 may allocate a muting symbol corresponding to the muting resources based on the first and second information across the PRB band of the allocated PUSCH resources. In another example, the processor 950 may allocate the muting resources based on the explicit frequency allocation position of the muting resources when the second information includes the explicit frequency allocation position.

In an embodiment, the processor 950 may allocate the muting resources to at least one of the CP-OFDM scheme in which transform-precoding is deactivated and the DFT-S-OFDM scheme in which the transform-precoding is activated. For example, when a muting symbol according to the allocated muting resources overlaps a symbol including the DM-RS, the processor 950 may not apply muting to the overlapping muting symbol. In another example, when the transform-precoding is activated and the muting symbol according to the muting resources overlaps a symbol including the PT-RS, the processor 950 may not apply muting to the overlapping muting symbol.

According to an embodiment, the processor 950 may transmit the PUSCH signal to the serving base station based on the allocated remaining resources.

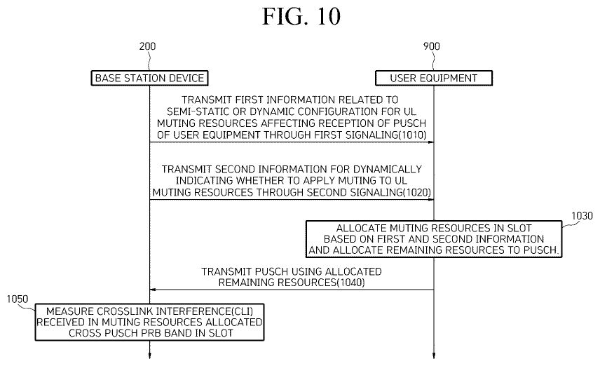

FIG. 10 is a flowchart of a muting resource allocation method according to an embodiment.

Referring to FIG. 10, in operation 1010, the base station device 200 transmits the first information related to the semi-static or dynamic configuration of the uplink muting resources to the user equipment 900 through first signaling in order to measure crosslink interference affecting reception of the PUSCH, and the user equipment 900 may receive the first information.

In operation 1020, the base station device 200 transmits the second information for dynamically indicating whether to apply muting to the muting resources according to the first information to the user equipment 900 through the second signaling, and the user equipment 900 may receive the second information.

In operation 1030, the user equipment 900 may allocate the muting resources in the slot based on the first and second information, and allocate the remaining resources to the PUSCH.

In operation 1040, the base station device 200 may receive the PUSCH signal transmitted using the remaining resources other than the muting resources in the slot based on the first and second information from the user equipment 900.

In operation 1050, the base station device 200 may measure the CLI received in the muting resources allocated across the PRB band of the PUSCH in the slot.

Thus, with the user equipment 900 according to the embodiment, it is possible to deactivate (mute) resources likely to cause crosslink interference by overlapping a slot and a subcarrier in which the CLI-RS signal is transmitted in the SBFD communication, thereby supporting more accurate measurement of the crosslink interference.

Therefore, with the base station device 200 according to the embodiment, it is possible to prevent or mitigate various problems that occur due to failing to accurately estimate the CLI-RS signal, such as beamforming/management failure, link disconnection due to a CSI error, increase in adaptive modulation/coding error, or increase in inter-cell interference.

It should be understood that the various embodiments of the present disclosure and the terms used therein are not intended to limit the technical features described in the present disclosure to specific embodiments, and include various modifications, equivalents, or substitutes of the embodiments. In connection with the description of the drawings, similar or related components may be denoted by similar reference numerals. A singular form of a noun corresponding to an item may include one or more items unless explicitly indicated otherwise in the context. In the present disclosure, phrases such as “A or B,” “at least one of A and B,” “at least one of A or B,” “A, B or C,” “at least one of A, B and C,” and “at least one of A, B, or C” may include any one of the items listed in the phrase, or any combination thereof. Terms such as “first” and “second” may be used merely to distinguish a component from other components, and do not limit the components in any other respect (for example, importance or order). When a certain (for example, first) component is mentioned as being “coupled” or “connected” to another (for example, second) component with or without the terms “functionally” or “communicatively,” this means that the component can be connected to the other component directly (for example, by a cable), wirelessly, or via a third component.

The term “module” used in the present disclosure may include a unit implemented in hardware, software, or firmware, and may be used interchangeably with terms such as logic, logic block, component, or circuit, for example. The module may be an integrally configured component or a minimum unit or a part of the component that performs one or more functions. For example, according to an embodiment, the module may be implemented in the form of an ASIC.

Various embodiments of the present disclosure may be implemented as software (for example, a program) including one or more instructions stored in a storage medium (for example, an internal memory, an external memory, or the memory 230 of FIG. 2) that can be read by a machine (for example, user equipment). For example, a processor (for example, the processor 210) of a machine (for example, the base station device 200) may call at least one of one or more stored instructions from the storage medium and execute the instruction. This enables the machine to be operated to perform at least one function according to the at least one called instruction. The one or more instructions may include code generated by a compiler or code executable by an interpreter. The storage medium readable by the machine may be provided in the form of a non-transitory storage medium. Here, “non-transitory” only means that the storage medium is a tangible device and does not include a signal (for example, electromagnetic waves), and this term does not distinguish between a case in which data is stored semi-permanently in the storage medium and a case in which data is temporarily stored in the storage medium.

According to an embodiment, the method according to various embodiments disclosed in the present document may be included in or provided through a computer program product. The computer program product may be traded between a seller and a buyer as a product. The computer program product may be distributed in the form of a machine-readable storage medium (for example, a compact disc read only memory (CD-ROM)), or may be distributed online directly (for example, downloaded or uploaded) through an application store (for example, Play Store™) or between two user devices (for example, smartphones). In the case of online distribution, at least a part of the computer program product may be at least temporarily stored or temporarily generated in a machine-readable storage medium, such as a memory of a manufacturer's server, an application store's server, or a relay server.

The components according to various embodiments of the present disclosure may be implemented in the form of software, or hardware such as a digital signal processor (DSP), an FPGA, or an ASIC, and may perform predetermined roles. The “components” are not limited to the software or hardware, and each component may be configured to be on an addressable storage medium or configured to reproduce one or more processors. As an example, the components may include components such as software components, object-oriented software components, class components, and task components, processes, functions, properties, procedures, subroutines, segments of program code, drivers, firmware, microcode, circuits, data, databases, data structures, tables, arrays, and variables.

According to various embodiments, each (for example, a module or a program) of the components described above may include a single or a plurality of entities. According to various embodiments, one or more of the components described above or operations may be omitted, or one or more other components or operations may be added. Alternatively or additionally, a plurality of components (for example, modules or programs) may be integrated into a single component. In such a case, the integrated component may perform one or more functions of the plurality of components identically or similarly to those performed by the corresponding components of the plurality of components prior to the integration. According to various embodiments, operations performed by the module, program, or other component may be executed sequentially, in parallel, repeatedly, or heuristically, one or more of the operations may be executed in a different order or omitted, or one or more other operations may be added.

According to the present invention, it is possible to provide user equipment and a base station device capable of supporting stable measurement of a signal related to crosslink interference in an SBFD operation. Further, it is possible to stably transmit and receive a reference signal related to the crosslink interference in the SBFD operation. In addition, it is possible to provide various effects that are directly or indirectly ascertained through the present disclosure.

What is claimed is:

1. User equipment comprising:
a communication module configured to transmit signals to and receive signals from a serving base station; and
a processor,
wherein the processor is configured to
receive first information related to semi-static configuration or dynamic configuration of uplink muting resources from the serving base station through first signaling via the communication module, the uplink muting resources being related to crosslink interference (CLI) measurement for reception of a physical uplink shared channel (PUSCH) of the serving base station,
receive second information indicating whether to apply muting to the muting resources dynamically from the serving base station through second signaling via the communication module, and
transmit the PUSCH to the serving base station through remaining resources other than muting resources in a slot determined based on the first and second information.

2. The user equipment of claim 1, wherein the first information includes a time-domain position and a frequency-domain muting pattern of at least one muting symbol in the slot.

3. The user equipment of claim 2, wherein the frequency-domain muting pattern includes a comb offset which is one of {0, 1}.

4. The user equipment of claim 1, wherein the processor is configured to determine the muting resources based on the first and second information across a physical resource block (PRB) band of PUSCH resources on which the PUSCH is transmitted.

5. The user equipment of claim 4, wherein the processor is configured to acquire a transmission PRB of the PUSCH and the second information through downlink control information (DCI) scheduling the PUSCH.

6. The user equipment of claim 1, wherein the processor is configured to determine the muting resources based on an explicit frequency allocation position when the second information includes the explicit frequency allocation position of the muting resources.

7. The user equipment of claim 1, wherein the first signaling includes at least one of signaling including radio resource control (RRC) signaling of a Uu link or SL, master information block (MIB), system information block (SIB), DCI/UCI/SCI (DL/UL/SL control information), and a medium access control element (MAC CE).

8. The user equipment of claim 1, wherein the second signaling includes at least one of the signaling including DCI and MAC CE.

9. The user equipment of claim 1, wherein the processor is configured not to apply muting to at least one symbol corresponding to the muting resources determined based on the first and second information when the at least one symbol overlaps a symbol including a demodulation RS (DM-RS).

10. The user equipment of claim 1,
wherein at least one symbol corresponding to the muting resources determined based on the first and second information is either a symbol on which transform-precoding is deactivated or a symbol on which transform-precoding is activated, and
the processor is configured not to apply muting to the at least one symbol when the at least one symbol is a symbol on which transform-precoding is activated and overlaps a symbol including a phase tracking RS (PT-RS).

11. The user equipment of claim 10,
wherein the symbol on which transform-precoding is deactivated is a CP-OFDM symbol, and
the symbol on which transform-precoding is activated is a DFT-S-OFDM symbol.

12. A base station device comprising:
a communication module configured to transmit and receive signals with user equipment in a serving cell; and
a processor,
wherein the processor is configured to, in an operation of measuring crosslink interference (CLI) affecting reception of a physical uplink shared channel (PUSCH) of the user equipment,
transmit first information related to semi-static or dynamic configuration of uplink muting resources to the user equipment through first signaling,
transmit second information for dynamically indicating whether to apply muting to the uplink muting resources to the user equipment through second signaling, and
receive the PUSCH from the user equipment through remaining resources other than muting resources determined based on the first and second information.

13. The base station device of claim 12, wherein the first information includes a time-domain position, and a frequency-domain muting pattern of at least one muting symbol in a slot of the muting resources.

14. The base station device of claim 13, wherein the frequency-domain muting pattern includes a comb offset that is one of {0, 1}.

15. The base station device of claim 12, wherein the processor is configured to measure crosslink interference (CLI) received in the muting resources allocated across a physical resource block (PRB) band of a PUSCH in a slot.

16. The base station device of claim 15, wherein the processor is configured to transmit PRB allocation information of the PUSCH to the user equipment through downlink control information (DCI) indicating PUSCH scheduling information.

17. The base station device of claim 12, wherein the processor is configured to transmit the second information including the explicit frequency allocation position of the muting resources in case of designating a frequency allocation position of the muting resources differently from a PUSCH frequency allocation position.

18. The base station device of claim 12, wherein the first signaling includes at least one of signaling including radio resource control (RRC) signaling of a Uu link or SL, master information block (MIB), system information block (SIB), DCI/UCI/SCI (DL/UL/SL control information), and a medium access control element (MAC CE).

19. The base station device of claim 12, wherein the second signaling includes at least one of the signaling including DCI and MAC CE.

20. The base station device of claim 12, wherein the processor is configured to transmit the first information and the second information for applying muting to at least one of a symbol on which transform-precoding is deactivated and a symbol on which transform-precoding is activated.
